(19) United States
(12) Patent Application Publication
(10) Pub. No.: US 2008/0008628 A1
(43) Pub. Date: Jan. 10, 2008

(54) MICROFLUIDIC REACTION CHIP AND METHOD OF MANUFACTURING THE SAME

(75) Inventors: Chin-sung PARK, Yongin-si (KR); Jin-tae KIM, Yongin-si (KR); Kak NAMGOONG, Yongin-si (KR); Su-hyeon KIM, Yongin-si (KR); Young-sun LEE, Yongin-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-si (KR)

(21) Appl. No.: 11/673,291

(22) Filed: Feb. 9, 2007

(30) Foreign Application Priority Data
Jul. 6, 2006 (KR) 10-2006-0063536

(51) Int. Cl. B01J 19/00

(52) U.S. Cl. 422/130

(57) ABSTRACT

A microfluidic reaction chip and a method of manufacturing the same include a lower substrate, an upper substrate disposed on the lower substrate, wherein a lower surface of the upper substrate and an upper surface of the lower substrate face each other and are bonded to each other, at least one chamber formed in the upper surface of the lower substrate is configured to contain a fluid and at least one channel formed in the lower surface of the upper substrate, the at least one channel is in fluid communication with the at least one chamber.

This application claims priority to Korean Patent Application No. 10-2006-0063536, filed on Jul. 6, 2006, and all the benefits accruing therefrom under 35 U.S.C. §119, the contents of which in its entirety are herein incorporated by reference.

### BACKGROUND OF THE INVENTION

1. Field of the Invention

The present invention relates to microfluids, and more particularly, to a microfluidic reaction chip and a method of manufacturing the microfluidic reaction chip.

2. Description of the Related Art

A microfluid reaction chamber contains a very small amount of fluid and a biochemical reaction of the fluid is generated within the microfluid reaction chamber, for example, a polymerase chain reaction (“PCR”), in order to analyze biochemical characteristics such as gene manifestation aspects, gene defects and protein distribution of the fluid.

U.S. Pat. Nos. 6,168,948 and 7,027,638 disclose conventional microfluidic reaction chips. In such microfluidic reaction chips, a plurality of substrates are laminated and adhered to each other. Also, chambers and channels are only formed in one substrate. The conventional microfluidic reaction chips can be rather easily manufactured. However, since the channels and chambers are only formed in one substrate, many channels and chambers cannot be integrated into a small-sized microfluidic reaction chip. In particular, silicon (Si), which has excellent thermal conductivity, is primarily used to manufacture the substrates. However, when the channels are formed in the silicon substrate by wet etching, the channels may be undercut as illustrated by dotted lines in FIG. 1.

FIG. 1 is a schematic top plan view of a conventional microfluidic reaction chip of the prior art in the case where channels in the microfluidic reaction chip are undercut.

Referring to FIG. 1, when a channel 15 is formed in a silicon substrate 10 by wet etching, an actual etching line E, indicated by a dotted line, is different from a designed etching line D, indicated by a solid line, at curved parts of the channel 15 due to a difference in an etching rate according to a crystalline surface of the silicon. This is referred to as “an undercut”. The undercut makes forming channels with a number of curved parts in the substrate difficult and thus, integrating the chambers and channels into the microfluidic reaction chip is difficult. If the channels are formed by dry etching, an undercut may not occur. However, a cost of manufacturing channels by dry etching is greater than a cost of forming channels by wet etching. Also, in order to vary the etching depths when forming the chambers and channels, additional processes may be required and thus, further complicating the integration of the chambers and channels.

### BRIEF SUMMARY OF THE INVENTION

The present invention provides an exemplary embodiment of a microfluidic reaction chip with an improved structure which makes it possible to easily design chambers and channels and a method of manufacturing the microfluidic reaction chip.

According to an exemplary embodiment of the present invention, there is provided a microfluidic reaction chip including a lower substrate, an upper substrate disposed on the lower substrate, wherein a lower surface of the upper substrate and an upper surface of the lower substrate face each other and are bonded to each other, at least one chamber formed in the upper surface of the lower substrate is configured to contain a fluid and at least one channel formed in the lower surface of the upper substrate, the at least one channel is in fluid communication with the at least one chamber.

The lower substrate may include a thermal conductivity higher than a thermal conductivity of the upper substrate.

The lower substrate may be formed of a silicon or a thermally conductive metal.

The thermally conductive metal may include one metal selected from the group including a silver (Ag), a copper (Cu), an aluminum (Al), an iron (Fe) and an alloy of one of the foregoing metals.

At least a portion of the upper substrate may be transparent.

The upper substrate may include at least a portion which is configured to allow fluorescence detection of a reaction within the at least one chamber.

The upper substrate may be formed of one of a glass or a plastic.

The plastic may be one selected from the group consisting of a poly methyl meta acrylate (“PMMA”), a poly carbonate (“PC”) and a poly dimethyl siloxane (“PDMS”).

The upper substrate may include an inlet hole and an outlet hole configured to facilitate flow of the fluid in and out of the at least one channel.

A hydrophobic coating layer may be formed by coating a hydrophobic material on an inner surface defining at least one of the at least one chamber and the at least one channel.

The hydrophobic material may be any of a parylene group material or a polytetrafluoroethylene (“Teflon®”) group material.

The hydrophobic coating layer may be formed by chemical vapor deposition (“CVD”) of the hydrophobic material.

The hydrophobic material may be directly coated on an inner surface defining at least one of the at least one chamber and the at least one channel.

The hydrophobic coating layer lacks a silane group material.

The at least one chamber may have a depth greater than a depth of the at least one channel.

According to another exemplary embodiment of the present invention, there is provided a method of manufacturing a microfluidic reaction chip, the method including forming at least one chamber configured for containing a fluid in an upper surface of a lower substrate, forming at least one channel for fluid flow in a lower surface of an upper substrate and bonding the upper surface of the lower substrate and the lower surface of the upper substrate to each other, the at least one channel is in fluid communication with the at least one chamber.

The forming the at least one chamber may include forming a chamber pattern with at least one chamber spot corresponding to the at least one chamber exposed on the upper surface of the lower substrate by photolithography, etching the at least one chamber spot and removing the chamber pattern for the at least one chamber.

The forming the at least one channel may include forming a channel pattern with at least one channel spot corresponding to the at least one channel exposed on the lower surface of the upper substrate by photolithography, sand blasting the at least one channel spot and removing the channel pattern for the at least one channel.

The bonding the lower substrate and the upper substrate may include a bonding process using at least one bonding method selected from the group consisting of an anodic bonding, a fusion bonding, an adhesive bonding and a polymer bonding.

The forming the at least one chamber may include forming the lower substrate of one of a silicon and a thermally conductive metal.

The thermally conductive metal may include one metal selected from the group consisting of a silver (Ag), a copper (Cu), an aluminum (Al), an iron (Fe) and an alloy of one of the foregoing metals.

The forming the at least one channel includes the upper substrate with at least a transparent portion to facilitate fluorescence detection of a fluid reaction which takes place in the at least one chamber.

The forming the upper substrate may include forming the upper substrate of one of a glass and a plastic.

The plastic may be a poly methyl meta acrylate (“PMMA”), a poly carbonate (“PC”) and a poly dimethyl siloxane (“PDMS”).

The method of manufacturing a microfluidic reaction chip may further include forming an inlet hole and an outlet hole in the upper substrate before the bonding to facilitate flow of the fluid in and out of the at least one channel and the at least one chamber.

The forming of the inlet hole and the outlet hole may include forming a hole pattern which includes at least a first hole spot corresponding to the inlet hole and a second hole spot corresponding to the outlet hole, the first and second hole spots are exposed on the upper surface of the upper substrate by photolithography, sand blasting the first and second hole spot and removing the pattern for the holes.

The method of manufacturing a microfluidic reaction chip may further include forming a hydrophobic coating layer by coating a hydrophobic material on an inner surface defining at least one of the at least one chamber and the at least one channel.

In the forming of a hydrophobic coating layer, the hydrophobic material may be one of a parylene group material or a Teflon® group material.

The forming the hydrophobic coating layer may be formed by depositing the hydrophobic material on an inner surface of at least one of the at least one chamber and the at least one channel using chemical vapor deposition (“CVD”).

The forming the hydrophobic coating layer may be formed by directly coating the hydrophobic material on an inner surface of at least one of the at least one chamber and the at least one channel.

In the forming the hydrophobic coating, the hydrophobic coating layer may lack a silane group material.

The forming the at least one chamber may include forming the at least one chamber with a depth which may be greater than a depth of the at least one channel.

### BRIEF DESCRIPTION OF THE DRAWINGS

The above and other aspects, features and advantages of the present invention will become more apparent by describing in more detail exemplary embodiments thereof with reference to the accompanying drawings, in which:

FIG. 1 is an enlarged partial schematic top plan view of a conventional microfluidic reaction chip of the prior art in a case where the channels in the microfluidic reaction chip are undercut;

FIG. 2 is a schematic top plan view of a microfluidic reaction chip according to an exemplary embodiment of the present invention;

FIG. 3 is a schematic cross-sectional view of an exemplary embodiment of the microfluidic reaction chip of FIG. 2 taken along line III-III of FIG. 2;

FIGS. 4A through 4C are computer simulation diagrams of a schematic perspective view of a chamber sequentially illustrating formation of bubbles in the chamber of the exemplary embodiment of the microfluidic reaction chip of FIG. 2 as a fluid flows therethrough;

FIGS. 5A through 5J are cross-sectional views sequentially illustrating a method of manufacturing the exemplary embodiment of the microfluidic reaction chip of FIG. 2 according to an exemplary embodiment of the present invention; and

FIG. 6 is a graph showing fluorescence values detected after a polymerase chain reaction (“PCR”) was performed on three different types of microfluidic reaction chips.

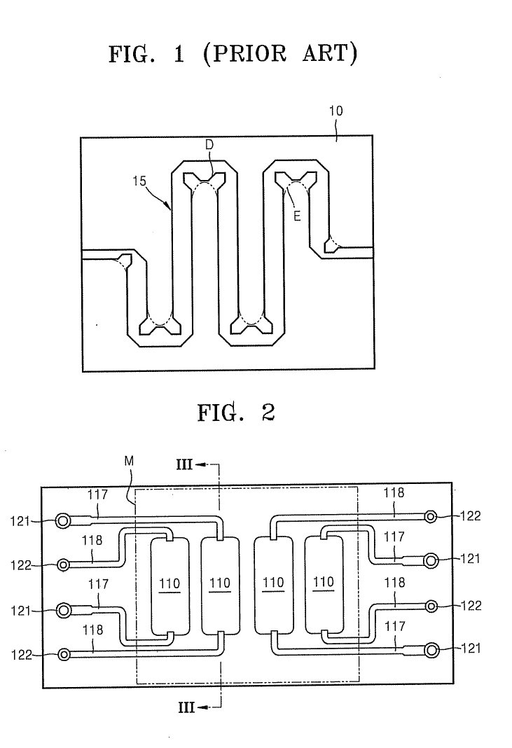

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in further detail with reference to the accompanying drawings.

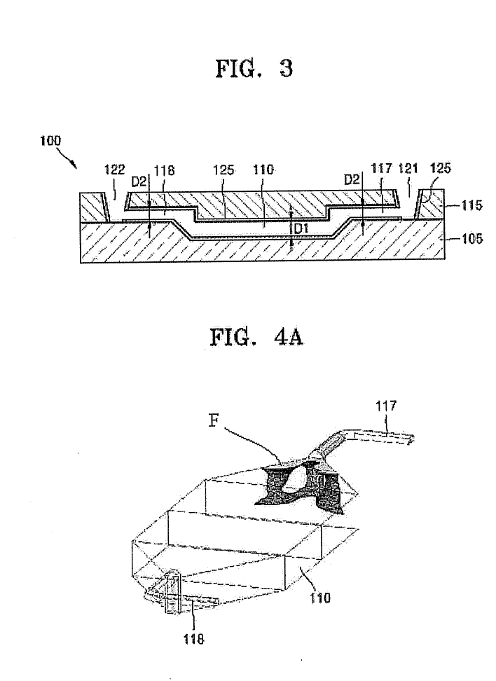

FIG. 2 is a schematic top plan view of a microfluidic reaction chip according to an exemplary embodiment of the present invention and FIG. 3 is a schematic cross-sectional view of the exemplary embodiment of the microfluidic reaction chip of FIG. 2 taken along line III-III of FIG. 2.

Referring to FIGS. 2 and 3, a microfluidic reaction chip 100 according to an exemplary embodiment of the present invention includes a lower substrate 105 and an upper substrate 115. The upper substrate 115 is bonded to the lower substrate 105 such that a lower surface of the upper substrate 115 faces an upper surface of the lower substrate 105. In the current exemplary embodiment, the upper substrate 115 is laminated and bonded on the lower substrate 105. Also, the microfluidic reaction chip 100 includes chambers 110 formed on the upper surface of the lower substrate 105 and channels 117 and 118, each of the channels are formed on the lower surface of the upper substrate 115. In addition, the microfluidic reaction chip 100 further includes inlet holes 121 and outlet holes 122 formed in the upper substrate 115.

A fluid F is introduced into the chamber 110, and a biochemical reaction occurs in the chamber 110. The result of the biochemical reaction in the chamber 110 can be detected by a fluorescence detection method. The channel 117 is an inlet channel through which the fluid F flows into the chamber 110 and the channel 118 is an outlet channel through which the fluid F flows out from the chamber 110. One end of the inlet channel 117 is connected with the chamber 110 and an opposite end of the inlet channel 117 is connected with the inlet holes 121. Similarly, one end of the outlet channel 118 is connected with the chamber 110 and an opposite end of the outlet channel 118 is connected with the outlet hole 122. The fluid F flows into the microfluidic reaction chip 100 through the inlet holes 121 and flows out of the microfluidic reaction chip 100 through the outlet holes 122.

In the current embodiment, a depth of the chamber 110 (D1) is greater than a depth of the channels 117 (D2) and 118 (D2). Accordingly, the volume of fluid in the chamber 110 can be increased by varying the total volume of fluid within the microfluidic reaction chip 100. In other words, a minimum amount of fluid which is required for detecting the result of the biochemical reaction is less than the minimum amount of fluid which is required in the conventional art, and thus a limit of detection (“LOD”) is improved.

In exemplary embodiments, the lower substrate 105 may immediately transmit heat from a heater (not shown) to the chamber 110 during a biochemical reaction such as a polymerase chain reaction (“PCR”). Therefore, the lower substrate 105 may be a silicon substrate or a thermally conductive metal substrate, which have relatively high thermal conductivity. Exemplary embodiments of suitable thermally conductive metals include silver (Ag), copper (Cu), aluminum (Al), iron (Fe) and including alloys of the foregoing metals.

In another exemplary embodiment, the upper substrate 115 may have a lower thermal conductivity than the thermal conductivity of the lower substrate 105. However, the upper substrate 115 may be formed of a material having better processibility than the lower substrate 105 in order to precisely manufacture the channels 117 and 118 according to their design, since the channels 117 and 118 have curved lines and smaller depths D2 than the depth D1 of the chamber 110. In another exemplary embodiment, the upper substrate 115 may be formed of a transparent substrate to facilitate detection of a result of the biochemical reaction using a fluorescence detection method. Alternatively, the upper substrate 115 may be formed of glass or plastic. Exemplary embodiments of the plastic include poly methyl meta acrylate (“PMMA”), poly carbonate (“PC”) or poly dimethyl siloxane (“PDMS”). In the current exemplary embodiment, the upper substrate 115 is a glass substrate, and more specifically, a glass substrate Pyrex®) code 7740 glass.

In another exemplary embodiment, a hydrophobic coating layer 125 formed by coating a hydrophobic material is disposed inside the chamber 110, the inlet channel 117, the outlet channel 118, the inlet holes 121 and the outlet holes 122. The surface of silicon (Si) is easily oxidized by oxygen contained in air. The surface on which silicon dioxide (“SiO2”) is coated converts into a hydrophilic surface having a contact angle of about 10 degrees to about 20 degrees.

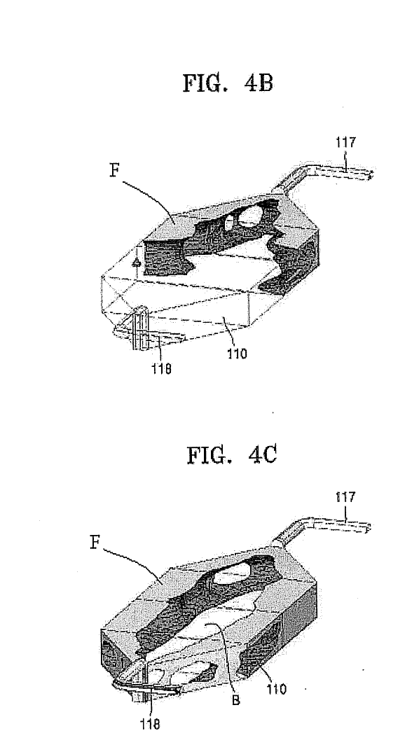

FIGS. 4A through 4C are computer simulation diagrams of a schematic perspective view of a chamber sequentially illustrating formation of bubbles in the chamber of the exemplary embodiment of the microfluidic reaction chip of FIG. 2 as a fluid flows therethrough.

Referring to FIGS. 4A through 4C, when the fluid F flows from the inlet channel 117 into the chamber 110 formed in the lower substrate 105, the fluid F flows directly along an inner surface defining the chamber 110 and then outside of the chamber 110 through the outlet channel 118 since the inner surface of the chamber 110 is coated with SiO2, thereby forming bubbles B within the chamber 110. The bubbles B make detection of the biochemical reaction in the chamber 110 difficult. Accordingly, a hydrophobic coating layer 125 is disposed in the microfluidic reaction chip 100 to reduce or effectively prevent the formation of bubbles B.

The hydrophobic coating layer 125 may be formed of a parylene group material or a Teflon® group material. In the current exemplary embodiment, the hydrophobic coating layer 125 may be formed of parylene by chemical vapor deposition (“CVD”) of parylene mixed with dimer; the parylene dimer is a hydrophobic material. Since a high temperature or a high pressure is required to bond the lower substrate 105 and the upper substrate 115, the hydrophobic coating layer 125 may be formed after the bonding process is completed. In the CVD, a N-type parylene dimer with a small molecular size may be used to be densely adhered to the inner surface of the chamber 110 and to smoothly pass through the channels 117 and 118. In general, a silane group material is used as an adhesion promoter to deposit parylene. However, in the current exemplary embodiment, a parylene group material is directly deposited on the inner surface of the chamber 110, the channels 117 and 118, the inlet holes 121 and the outlet holes 122 without using such an adhesion promoter.

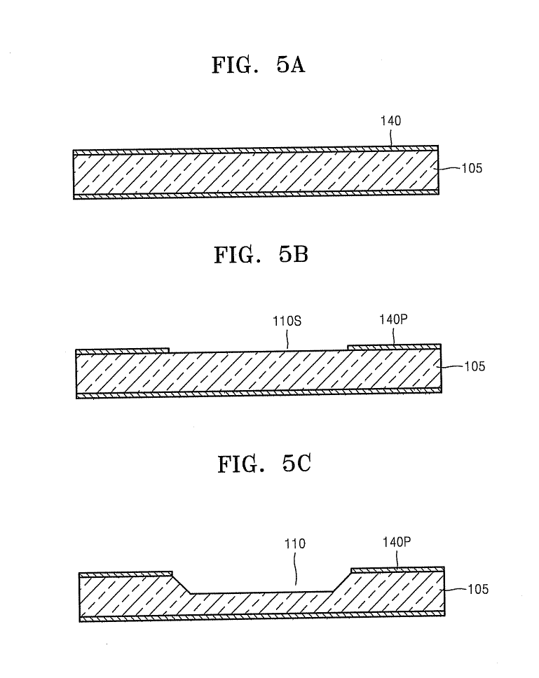

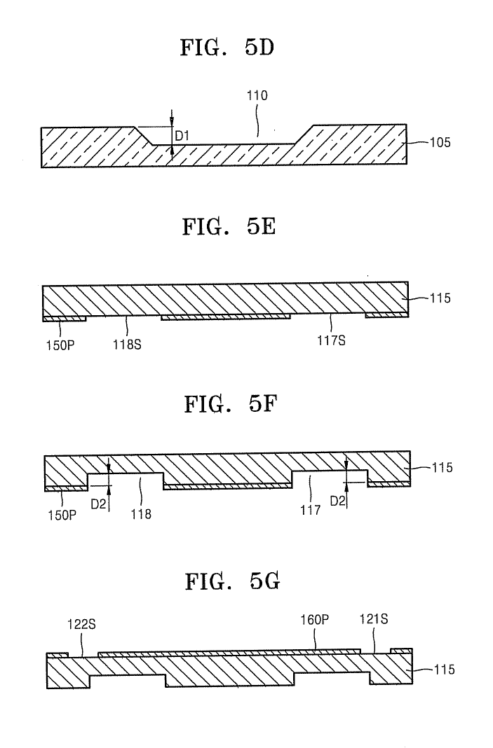

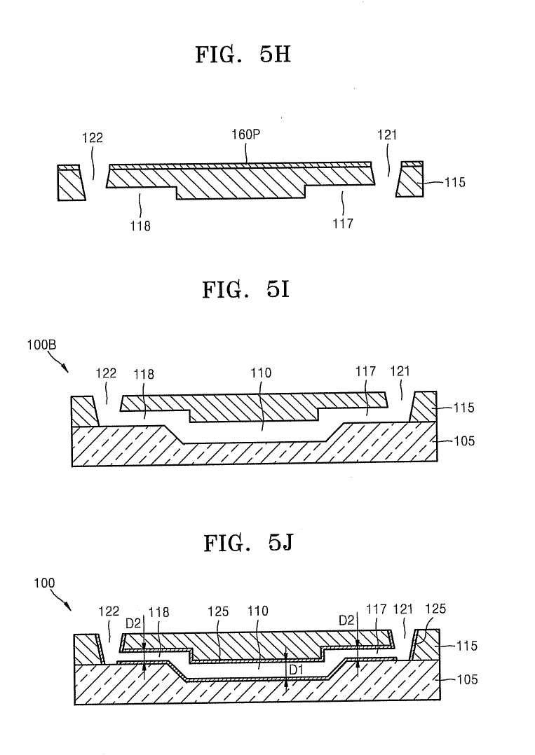

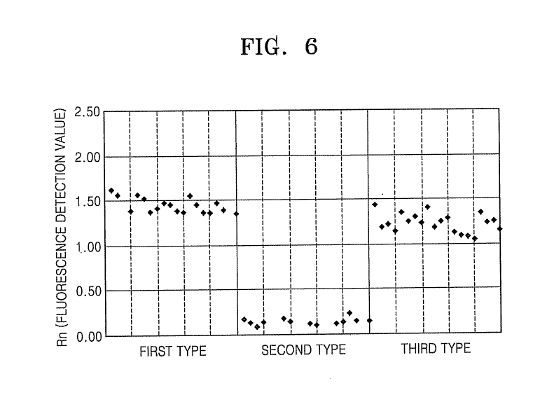

FIGS. 5A through 5J are schematic cross-sectional views sequentially illustrating a method of manufacturing the microfluidic reaction chip 100 according to an exemplary embodiment of the present invention.

Referring to FIGS. 5A through 5J, an exemplary embodiment of a method of manufacturing the microfluidic reaction chip 100 is divided into forming the chamber 110 in the lower substrate 105 (refer to FIGS. 5A through 5D), forming the channels 117 and 118 in the upper substrate 115 (refer to FIGS. 5E through 5F), forming the inlet holes 121 and the outlet holes 122 in the upper substrate 115 (refer to FIGS. 5G through 5H), bonding the lower substrate 105 to the upper substrate 115 (refer to FIG. 5I) and forming the hydrophobic coating layer 125 (refer to FIG. 5J).

In the exemplary embodiment, the process of forming the chamber 110 includes forming a chamber pattern 140P on the upper surface of the lower substrate 105 by photolithography as illustrated sequentially in FIGS. 5A and 5B, forming the chamber 110 by etching as illustrated in FIG. 5C and removing the chamber pattern 140P as illustrated in FIG. 5D. In further detail, a silicon dioxide layer 140 is formed on the lower substrate 105 by thermal oxidation, a liquid photoresist (not shown) is coated on the lower substrate 105 by spin coating, and the photoresist is partially removed through exposure, development and bake processes (refer to FIG. 5A). The chamber pattern 140P is formed by removing a part of the silicon dioxide layer 140 using a buffered oxide etchant (“BOE solution”) in the region where the photoresist has been removed (refer to FIG. 5B). The region where the part of the silicon dioxide layer 140 is removed becomes a chamber spot 110S corresponding to where the chamber 110 is to be formed.

The etching method used in the manufacture of the chamber 110 may be by wet etching or dry etching. However, since the structure of the chamber 110 is relatively simple, wet etching may be used considering the cost thereof. Exemplary embodiments of the wet etching may be a method of immersing the lower substrate 105, on which the pattern 140P is formed, in a container or bathtub containing a tetra methyl ammonium hydroxide solution (“TMAH”). When the manufacture of the chamber 110 is completed (refer to FIG. 5C), the lower substrate 105 is immersed in a hydrogen fluoride (“HF”) solution to remove the pattern 140P (refer to FIG. 5D). In addition, a new silicon dioxide layer (not shown) may be formed on the lower substrate 105 by thermal oxidation in order to prevent a reaction fluid from being absorbed by the lower substrate 105.

In an alternative exemplary embodiment, if the lower substrate 105 is formed of a thermally conductive metal, a general metal molding method such as an injection molding and a pressing process can be used to form the chamber 110.

The process of forming the channels 117 and 118 includes forming a channel pattern 150P on the lower surface of the upper substrate 115 by photolithography as illustrated in FIG. 5E, wherein the upper substrate 115 is formed of glass, forming the channels 117 and 118 by sand blasting the upper substrate 115 as illustrated in FIG. 5F and removing the channel pattern 150P. The pattern 150P as illustrated in FIG. 5E is formed by laminating a dry film resist (“DFR”) on the lower surface of the upper substrate 115 formed of glass and exposing channel spots 117S and 118S corresponding to where the channels 117 and 118 are to be formed through exposure and development processes. Since the upper substrate 115 is formed of glass, the channels 117 and 118 may be formed on the exposed channel spots 117S and 118S by sand blasting, instead of dry etching. In the process of forming the chamber 110 and the channels 117 and 118, a depth (D1) of the chamber 110 is greater than a depth (D2) of the channels 117 and 118.

In an alternative exemplary embodiment, if the upper substrate 115 is formed of plastic, a general plastic molding method such as an injection molding and a pressing process can be used to form the channels 117 and 118.

The process of forming the holes 121 and 122 includes forming a hole pattern 160P on the upper surface of the upper substrate 115 by photolithography as illustrated in FIG. 5G, wherein the upper substrate 115 is formed of glass, forming the inlet hole 121 and the outlet hole 122 by sand blasting the upper substrate 115 as illustrated in FIG. 5H and removing the hole pattern 160P. The hole pattern 160P, similarly with the pattern 150P, is formed by laminating a dry film resist (“DFR”) on the upper surface of the upper substrate 115 formed of glass and exposing hole spots 121S and 122S where the inlet hole 121 and outlet hole 122 are to be formed, respectively, through exposure and development processes. As described with respect to the forming of the channels 117 and 118, the inlet hole 121 and the outlet hole 122 may be formed by sand blasting.

In an alternative exemplary embodiment, if the upper substrate 115 is formed of plastic, a general plastic molding method such as an injection molding, a press process and drilling can be used to form the inlet hole 121 and outlet hole 122.

In the boding process as illustrated in FIG. 5I, in order to connect the chamber 110 formed in the lower substrate 105 with the channels 117 and 118 formed in the upper substrate 115, the upper surface of the lower substrate 105 and the lower surface of the upper substrate 115 are aligned to face each other and are then bonded.

In the current exemplary embodiment, the lower substrate 105 formed of silicon and the upper substrate 115 formed of glass are bonded using anodic bonding.

The anodic bonding will now be described in further detail.

The upper substrate 115 formed of glass is preheated, such that impurities including sodium (Na) and potassium (K) included in glass have electric charges, and a strong direct current voltage is applied between the upper substrate 115 and the lower substrate 105. Then, the impurities sodium (Na) and potassium (K) having electric charges move toward the side of electrodes and the silicon substrate and the glass substrate are bonded at the interface of the upper substrate 115 and the lower substrate 105 due to a strong charging phenomenon.

In another exemplary embodiment, when the upper substrate 115 and the lower substrate 105 are formed of the same material, fusion bonding can be used. In fusion bonding, the upper substrate 115 and the lower substrate 105 are fused by heating the upper substrate 115 and the lower substrate 105 at a high temperature. Also, when the upper substrate 115 and the lower substrate 105 are formed of metal or plastic, an adhesive bonding or a polymer bonding process can be used. In an adhesive bonding process, adhesives are sprayed on both the upper substrate 115 and the lower substrate 105 and the upper substrate 115 and the lower substrate 105 are then bonded. In a polymer bonding process, polymers having an adhesive characteristic under specific conditions are sprayed on both the upper substrate 115 and the lower substrate 105, and then the upper substrate 115 and the lower substrate 105 are bonded.

In the process of forming the hydrophobic coating layer 125, a chip 100B in which the upper substrate 115 and the lower substrate 105 are bonded is put in a CVD apparatus and a N-type parylene dimer is added to the chip 100B to form the hydrophobic coating layer 125 with a thickness of approximately 1500 angstroms (Å) in the chamber 110, the channels 117 and 118, the inlet hole 121 and the outlet hole 122. Since the hydrophobic coating layer 125 formed of a parylene group material is transparent, fluorescence detection can be performed. However, in order to accurately detect the result of the biochemical reaction using a fluorescence detection method, a portion of the upper surface of the upper substrate 115, not including the inlet hole 121 and the outlet hole 121, may need to be taped before a parylene deposition process in order to form a mask for preventing deposition. Then, when the parylene deposition process is completed, the mask can be removed. The region illustrated with the dotted line in FIG. 2 may be a region M where the mask for preventing deposition is formed.

In general, a silane group material, for example, 3-methacryloxylpropyltrimethoxysilane (“SILQUEST® Silane A-174”) is used as an adhesion promoter in the parylene deposition process. However, dyes used in fluorescence detection of a polymerase chain reaction (“PCR”), for example, SYBR Green I®, TOTO®, YOYO®, Hoechst®, cyanosine 4′,6-diaminidino-2-phenylindole (“DAPI”), 2′-(2-benzoxazolylethenyl)-6′-hydroxybenzothiazole (“BEBO”) and 4-[6-(Benzothiazol-2-yl)-(3-methyl-2,3-dihydro-(benzo-1,3-thiazole)-2-methylidene)]-1-methyl-quinolinium chloride (“BETO”) have a stronger bonding propensity with a silane group material than with a deoxyribonucleic acid (“DNA”). Therefore, if the silane group material was used as an adhesion promoter in forming the hydrophobic coating layer 125, the dyes would combine with the silane group material instead of the DNA, and thus, a fluorescence detection of a polymerase chain reaction (“PCR”) may be obstructed. Therefore, in the current exemplary embodiment, the silane group material is not included in the hydrophobic coating layer 125 and the parylene group material is directly deposited in the chamber 110, the channels 117 and 118, the inlet hole 121 and the outlet hole 122 without the need of an adhesion promoter.

In the present invention, a PCR was performed on three different types of a microfluidic reaction chip and an experiment was performed to determine whether the result of the PCR can be fluorescent detected. The first type of the microfluidic reaction chip was a microfluidic reaction chip without a hydrophobic coating layer 125 formed in the chamber 110 (refer to 100B of FIG. 5I), the second type of the microfluidic reaction chip was a microfluidic reaction chip with a coating layer formed of the silane group material only in the chamber 110 and the third type of the microfluidic reaction chip was a microfluidic reaction chip with a hydrophobic coating layer 125 formed of the parylene group material only in the chamber 110 (refer to 100 of FIG. 5J), however FIG. 5J illustrates the hydrophobic coating layer 125 formed on the channels 117 and 118, as well. A sample fluid having hepatitis B virus (“HBV”) plasmid DNA with a concentration of 106 copy/μl was injected into each of the three types of microfluidic reaction chips in order to perform a PCR with 40 thermal cycles and then the fluorescence values were measured using a photo diode. The dye used in the PCR fluorescence detection was SYBR Green I®.

FIG. 6 is a graph showing fluorescence values detected after a polymerase chain reaction (“PCR”) was performed on three different types of the microfluidic reaction chip. Twenty microfluidic reaction chips per each type were prepared to perform a PCR and the fluorescence detection values were obtained after completing 40 thermal cycles. The fluorescence values were measured and plotted, as illustrated in FIG. 6. Referring to FIG. 6, in the first and third type of the microfluidic reaction chip, reasonable fluorescence detection values (Rn) were measured after the PCR was performed. However, in the second type of the microfluidic reaction chip, significantly poorer fluorescence values were measured than the fluorescence values measured from the first and third type of the microfluidic reaction chip. According to the results of the experiment, the first and third type of the microfluidic reaction chip, corresponding to the current embodiment of the present invention, may be used for fluorescence detection of a biochemical reaction. In addition, if the microfluidic reaction chip includes the coating layer formed of the silane group material in the chamber 110, the microfluidic reaction chip cannot be used for fluorescence detection of a biochemical reaction.

As described above, in the microfluidic reaction chip according to the present invention, the chambers and channels are separately formed in the lower substrate and the upper substrate and thus, more chambers and channels can be formed in a predetermined sized chip. Therefore, the microfluidic reaction chip can be highly integrated.

In addition, in the microfluidic reaction chip in which the hydrophobic coating layer is formed in the chamber according to an exemplary embodiment of the present invention, a fluid is filled in the chamber without having bubbles and thus, fluorescence detection of a biochemical reaction can be easily performed.

Moreover, the hydrophobic coating layer formed of the parylene group material according to an exemplary embodiment of the present invention does not require an additional adhesion promoter. Instead, the parylene group material is directly deposited into the chamber and thus, a simple manufacturing process and cost reduction thereof can be achieved.

Finally, the parylene group material is a stable material having no reactivity and thus, does not affect a biochemical reaction. Therefore, an experiment for determining the types and amounts of additives required to suppress a reaction on the inner surface of the chamber according to the types of sample fluids is not necessary, wherein the experiment has been essential for a conventional florescence detection of a biochemical reaction.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A microfluidic reaction chip comprising:
a lower substrate;
an upper substrate disposed on the lower substrate, wherein a lower surface of the upper substrate and an upper surface of the lower substrate face each other and are bonded to each other;
at least one chamber formed in the upper surface of the lower substrate is configured to contain a fluid; and
at least one channel formed in the lower surface of the upper substrate, the at least one channel is in fluid communication with the at least one chamber.

2. The microfluidic reaction chip of claim 1, wherein the lower substrate has a thermal conductivity higher than a thermal conductivity of the upper substrate.

3. The microfluidic reaction chip of claim 1, wherein the lower substrate is formed of one of a silicon and a thermally conductive metal.

4. The microfluidic reaction chip of claim 3, wherein the thermally conductive metal includes one metal selected from the group consisting of silver, copper, aluminum, iron and an alloy of one of the foregoing metals.

5. The microfluidic reaction chip of claim 1, wherein at least a portion of the upper substrate is transparent.

6. The microfluidic reaction chip of claim 5, wherein the upper substrate is formed of one of a glass and a plastic.

7. The microfluidic reaction chip of claim 6, wherein the plastic is one selected from the group consisting of a poly methyl meta acrylate, a poly carbonate and a poly dimethyl siloxane.

8. The microfluidic reaction chip of claim 1, wherein the upper substrate includes an inlet hole and an outlet hole configured to facilitate flow of the fluid in and out of the at least one channel.

9. The microfluidic reaction chip of claim 1, wherein a hydrophobic coating layer is formed by coating a hydrophobic material on an inner surface defining at least one of the at least one chamber and the at least one channel.

10. The microfluidic reaction chip of claim 9, wherein the hydrophobic material is one of a parylene group material and a polytetrafluoroethylene group material.

11. The microfluidic reaction chip of claim 9, wherein the hydrophobic coating layer is formed by chemical vapor deposition of the hydrophobic material.

12. The microfluidic reaction chip of claim 9, wherein the hydrophobic material is directly coated on the inner surface of the at least one chamber and the at least one channel.

13. The microfluidic reaction chip of claim 9, wherein the hydrophobic coating layer lacks a silane group material.

14. The microfluidic reaction chip of claim 1, wherein the at least one chamber has a depth greater than a depth of the at least one channel.

15. A method of manufacturing a microfluidic reaction chip, the method comprising:
forming at least one chamber configured for containing a fluid in an upper surface of a lower substrate;
forming at least one channel for fluid flow in a lower surface of an upper substrate; and
bonding the upper surface of the lower substrate and the lower surface of the upper substrate to each other, the at least one channel is in fluid communication with the at least one chamber.

16. The method of claim 15, wherein the forming the at least one chamber comprises forming a chamber pattern with at least one chamber spot corresponding to the at least one chamber exposed on the upper surface of the lower substrate by photolithography, etching the at least one chamber spot and removing the chamber pattern for the at least one chamber.

17. The method of claim 15, wherein the forming the at least one channel comprises forming a channel pattern with at least one channel spot corresponding to the at least one channel exposed on the lower surface of the upper substrate by photolithography, sand blasting the at least one channel spot and removing the channel pattern for the at least one channel.

18. The method of claim 15, wherein the bonding the lower substrate and the upper substrate includes bonding by a process using at least one bonding method selected from the group consisting of anodic bonding, fusion bonding, adhesive bonding and polymer bonding.

19. The method of claim 15, wherein the forming the at least one chamber comprises forming the lower substrate of one of silicon and a thermally conductive metal.

20. The method of claim 19, wherein the thermally conductive metal includes one metal selected from the group consisting of silver, copper, aluminum, iron and an alloy of one of the foregoing metals.

21. The method of claim 15, wherein the forming the at least one channel includes the upper substrate with at least a transparent portion to facilitate fluorescence detection of a fluid reaction which takes place in the at least one chamber.

22. The method of claim 21, wherein the forming the upper substrate includes forming the upper substrate of one of glass and plastic.

23. The method of claim 22, wherein the plastic is one selected from the group consisting of poly methyl meta acrylate, poly carbonate and poly dimethyl siloxane.

24. The method of claim 15, further comprising forming an inlet hole and an outlet hole in the upper substrate before the bonding to facilitate flow of the fluid in and out of the at least one channel.

25. The method of claim 24, wherein the forming of the inlet hole and the outlet hole comprises forming a hole pattern which includes at least a first hole spot corresponding to the inlet hole and a second hole spot corresponding to the outlet hole, the first and second hole spots are exposed on the upper surface of the upper substrate by photolithography, sand blasting the first and second hole spots and removing the pattern for the holes.

26. The method of claim 15, further comprising forming a hydrophobic coating layer by coating a hydrophobic material on an inner surface defining at least one of the at least one chamber and the at least one channel.

27. The method of claim 26, wherein the forming a hydrophobic coating layer, the hydrophobic material is one of a parylene group material and a polytetrafluoroethylene group material.

28. The method of claim 26, wherein the forming the hydrophobic coating layer is formed by depositing the hydrophobic material on the inner surfaces of the at least one chamber and the at least one channel using chemical vapor deposition.

29. The method of claim 26, wherein the forming the hydrophobic coating layer is formed by directly coating the hydrophobic material on the inner surfaces of the at least one chamber and the at least one channel.

30. The method of claim 26, wherein the forming the hydrophobic coating layer, the hydrophobic coating layer lacks a silane group material.

31. The method of claim 15, wherein the forming the at least one chamber includes forming the at least one chamber with a depth greater than a depth of the at least one channel.

32. The microfluidic reaction chip of claim 1, wherein at least a portion of the upper substrate is configured to allow fluorescence detection of a reaction within the at least one chamber.

33. The method of claim 15, wherein the forming the at least one channel includes forming at least a portion of the upper substrate configured to allow fluorescence detection of a reaction within the at least one chamber.
